(19) United States
(12) Patent Application Publication
(10) Pub. No.: US 2006/0209331 A1
(43) Pub. Date: Sep. 21, 2006

(54) Image forming apparatus and image forming method

(75) Inventor: Naomi Nakane, Kanagawa-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Tokyo (JP)

(21) Appl. No.: 11/266,682

(22) Filed: Nov. 2, 2005

(30) Foreign Application Priority Data
Mar. 15, 2005 (JP) 2005-072864

(51) Int. Cl. G06K 15/00

(52) U.S. Cl. 358/1.14; 358/474

(57) ABSTRACT

An image forming apparatus of the present invention includes a reading unit, a making detecting unit, a determining unit, and an electronic-document generating unit. The reading unit reads at least one original document and generates original image data. The marking detecting unit detects a specific marking attached to the original document. The marking indicates that an electronic document of the original document has already been generated. The determining unit determines whether generation of the electronic document is enabled or disabled in accordance with the presence/absence or content of the detected marking. When the determining unit determines that the generation of the electronic document is disabled, the electronic-document generating unit does not generate the electronic document. When the determining unit determines that the generation of the electronic document is enabled, the electronic-document generates the electronic document in accordance with the original image data.

### BACKGROUND OF THE INVENTION

1. Field of the Invention

The present invention relates to image forming apparatuses and image forming methods. In particular, the present invention relates to an image forming apparatus and an image forming method for inputting documents and/or images and storing, printing or displaying them.

2. Description of the Related Art

Today, at companies and so on, in order to address the problems of information sharing and information storage places, digitizing documents printed on paper or the like and storing the resulting electronic documents as image data is becoming common.

Digitizing an enormous volume of print documents and storing the resulting electronic documents on, for example, a certain server in a company allows the information to be shared, so that a person who needs the information can easily access the electronic information whenever necessary. With respect to information that has already been digitized, hard copies thereof can be produced based on the electronic information, whenever necessary. Thus, there is no need to store the source print documents, thus contributing to a reduction in storage space.

However, not all documents are digitized in practice. For example, even today, the so-called “original documents” of tax/finance-related forms, finance-related documents, and so on (hereinafter referred to as “tax/finance-related documents”) are generally stored, at companies and so on, in the form of paper as the original documents without being digitized.

The reason is that, while there are restrictions in terms of a legal system, technology for reading one and only original document while allowing higher reproducibility therefor to be ensured than that for general documents and for printing the read electronic information with high reproducibility is not necessarily sufficient from a technical point of view.

More importantly, conventionally, for image forming apparatuses, such as scanners and so on, technology for ensuring data security, such as confidentiality and tamper protection, has not been sufficiently developed and thus has not put to practical use.

However, in recent years, technologies for higher resolution and higher color reproducibility for image forming apparatuses, such as scanners, are making considerable progress and security technologies for confidentiality improvement, tamper protection, and so on are also making great progress. Thus, from a technological point of view, digitizing the original documents of tax/finance-related documents or the like and storing and maintaining the resulting electronic documents as the electronic master copies can eliminate the need for continuously storing the source original documents in the form of paper.

In conjunction with the progress of those technologies, there is also a trend toward accepting digitized documents as the electronic master copies with respect to some tax/finance-related documents in the legal system as well.

At the same time, in conjunction with the rapid progress of the technologies for higher resolution and higher color reproducibility for image forming apparatuses, such as scanners, there is also a need for a technology for preventing copying of some specific documents, such as banknotes and negotiable securities.

For example, JP-A 9-305075 discloses a technology for strengthening or easing a criterion for determining specific documents, such as banknotes or negotiable securities, based on information obtained by pre-scanning and for prohibiting copying upon determining that the scanned document is a specific document.

Needless to say, tamper protection for an electronic-document original (an electronic master copy) is very important for digitizing a document, such as a tax/finance-related document. On the other hand, tamper protection and so on for the source paper document, after the digitization, are also important.

After creating an electronic master copy by reading a tax/finance-related document or the like, the obligation for storing the source paper document is not necessarily required. However, the source paper document may be stored in a company or the like for a certain period of time.

When another electronic master copy is mistakenly created again by reading the identical tax/finance-related document or the like with a scanner or the like during that period of time, there is a possibility that duplicate electronic master copies exist with respect to the electronic master copy that is supposed to be one.

There are also possibilities of occurrence of irregular practices. For example, a malicious third party can tamper with a source paper document and create another electronic master copy based on the tampered document.

In order to overcome such inconvenience, a strong demand exists for a security technology for disabling, after a tax/finance-related document or the like is read and the electronic master copy is once created, the re-reading of the source paper document.

The technology disclosed in above JP-A 9-305075, however, only protects the copying of specific documents, such as banknotes and negotiable securities, and thus does not necessarily satisfy the demand described above.

### SUMMARY OF THE INVENTION

The present invention has been made in view of the foregoing situations, and an object of the present invention is to provide an image forming apparatus and an image forming method which prevent, after a tax/finance-related document or the like is read and the electronic master copy thereof is once created, the re-reading of the source paper document, thereby making it possible to ensure high security.

To overcome the above-described problems, the present invention provides an image forming apparatus. The image forming apparatus includes a reading unit, a making detecting unit, a determining unit, and an electronic-document generating unit. The reading unit reads at least one original document and generates original image data. The marking detecting unit detects a specific marking attached to the original document. The marking indicates that an electronic document of the original document has already been generated. The determining unit determines whether generation of the electronic document is enabled or disabled in accordance with the presence/absence or content of the detected marking. When the determining unit determines that the generation of the electronic document is disabled, the electronic-document generating unit does not generate the electronic document. When the determining unit determines that the generation of the electronic document is enabled, the electronic-document generates the electronic document in accordance with the original image data.

The present invention further provides an image forming method. The image forming method includes a step of reading at least one original document and generating original image data; a step of detecting a specific marking attached to the original document; and a step of determining whether generation of an electronic document of the original document is enabled or disabled in accordance with the presence/absence or content of the detected marking. The image forming method further includes a step of not generating the electronic document, when it is determined in the determining step that the generation of the electronic document is disabled, and generating the electronic document in accordance with the original image data, when it is determined in the determining step that the generation of the electronic document is enabled. The method may further include a step of attaching, when the electronic document is generated, a specific marking to the original document from which the electronic document is generated.

According to the image forming apparatus and the image forming method of the present invention, after a tax/finance-related document or the like is read and the electronic master copy thereof is created, the re-reading of the source paper document can be prevented and high security can be ensured.

### BRIEF DESCRIPTION OF THE DRAWINGS

FIG. 1 is a diagram showing an example of the configuration of an image forming apparatus according to an embodiment of the present invention; and

FIG. 2 is a flow chart showing an example of the operation of the image forming apparatus according to the embodiment of the present invention.

### DESCRIPTION OF THE PREFERRED EMBODIMENT

An image forming apparatus and an image forming method according to an embodiment of the present invention will be described below with reference to the accompanying drawings.

In the following description, an “electronic document” refers to an “electronic master copy” of a special document, such as a tax/finance-related document or the like, unless otherwise particularly specified.

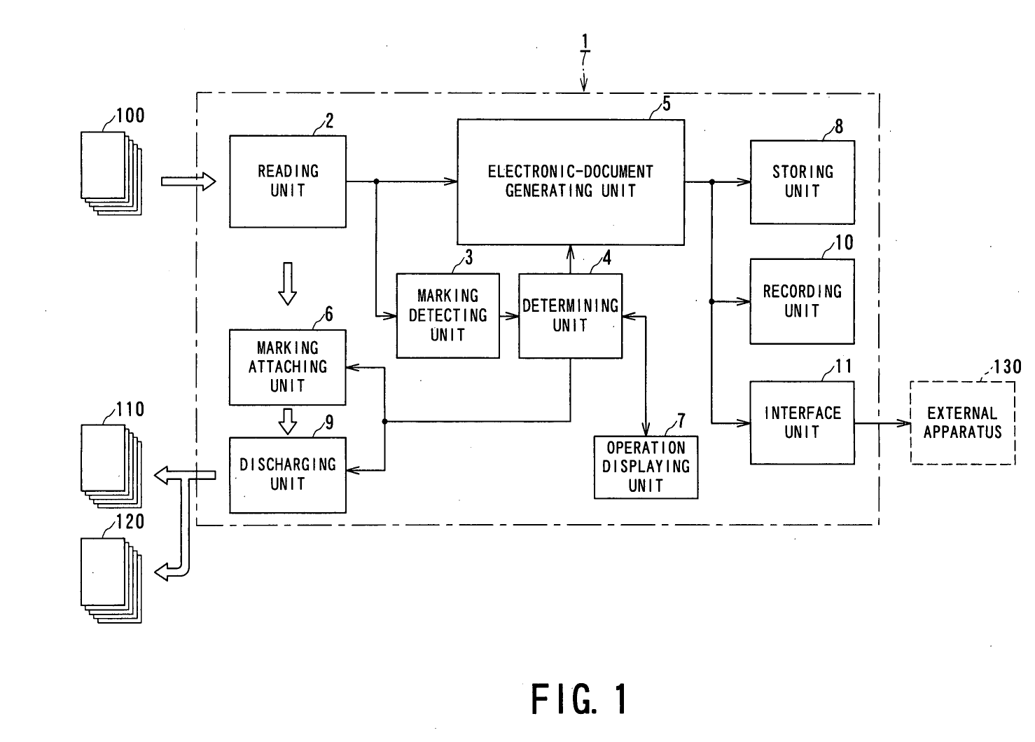

FIG. 1 is a diagram showing an example of the configuration of an image forming apparatus 1 according to an embodiment of the present invention.

The image forming apparatus 1 includes a reading unit 2, a marking detecting unit 3, a determining unit 4, an electronic-document generating unit 5, and a marking attaching unit 6. The reading unit 2 reads an original document or original documents 100 and generates original image data. The marking detecting unit 3 detects a specific marking attached to each original document 100, the marking indicating that the electronic document of the original document 100 has already been generated. The determining unit 4 determines whether the generation of the electronic document is enabled or disabled, in accordance with the presence/absence or the content of the marking. When the determining unit 4 determines that the generation of the electronic document is disabled, the electronic-document generating unit 5 does not generate the electronic document, and when the determining unit 4 determines that the generation of the electronic document is enabled, the electronic-document generating unit 5 generates the electronic document based on the original image data. When the electronic document is generated, the marking attaching unit 6 attaches a specific marking to the original document 100, which is the source of the generated electronic document.

The image forming apparatus 1 further includes an operation displaying unit (display unit) 7. When the determining unit 4 determines that the electronic document cannot be generated, the operation displaying unit 7 displays a message indicating so.

The image forming apparatus 1 further includes a discharging unit 9. After the original documents 100 are read, the discharging unit 9 sorts the original documents 100 into an original document or original documents 110 determined by the determining unit 4 that the generation of the electronic document(s) thereof is enabled and an original document or original documents 120 determined by the determining unit 4 that the generation of the electronic document(s) thereof is disabled and then discharges the sorted documents.

In addition, the image forming apparatus 1 includes a storing unit 8 for storing the electronic documents generated by the electronic-document generating unit 5, a recording unit 10 for printing the generated electronic documents, and an interface unit 11 for transmitting the generated electronic documents to an external apparatus 130.

A description below is given of a case in which the original document 100 is a special document, such as a tax/finance-related document, that requires high security. For example, using the operation displaying unit 7, a user sets a “normal mode” and a “special mode”. For handling a general document, setting the operation to the “normal mode” allows the image forming apparatus 1 to function as a typical scanner or an MFP. On the other hand, for handling a case in which the original document 100 is a special document, such as a tax/finance-related document, setting the operation to the “special mode” by using the operation displaying unit 7 allows high-security processing as described below.

The reading unit 2 is means for optically reads the original document(s) 100 and generating original image data. The reading unit 2 includes, for example, a light source for illuminating the original document 100 with light; a CCD sensor for converting light reflected from the original document 100 into electrical signals; an optical system for guiding the light, reflected from the original document 100, to the CCD sensor; and a driving system for mechanically driving the light source.

The electronic-document generating unit 5 performs appropriate image processing on the original image data output from the reading unit 2 and then generate an electronic document in accordance with the result of determination performed by the determining unit 4. When the determination result of the determining unit 4 indicates that the generation of the electronic document is enabled (permitted), the electronic-document generating unit 5 generates the electronic document and outputs the electronic document to the storing unit 8, the recording unit 10, or the interface unit 11.

When the determination result of the determining unit 4 indicates that the generation of the electronic document is disabled (prohibited), the electronic-document generating unit 5 does not generate the electronic document, or even if generates it, does not output the generated electronic document to the storing unit 8, the recording unit 10, or the interface unit 11.

For example, the image forming apparatus 1 may be configured so as to force the determination result of the determining unit 4 to indicate that the generation of an electronic document is enabled, when the image forming apparatus 1 is set to the “normal mode”. With this arrangement, regardless of the determination result, the electronic-document generating unit 5 can generate an electronic document in a normal manner (in this case, “the electronic document” is not only limited to the “electronic master copy” but also may be an electronic document in a general sense).

The storing unit 8 is means for storing the generated electronic document(s) and is implemented with, for example, an appropriate semiconductor memory or a HDD.

The recording unit 10 prints the generated electronic document(s). The printing means in the present invention is not particularly limited and can employ various systems, such as an electrophotographic system, inkjet system, and thermal system.

The interface unit 11 is an interface for transmitting/receiving an electronic document to/from the external apparatus 130 and may take any form.

The marking detecting unit 3 determines the presence/absence of a specific marking attached to a special document, such as a tax/finance-related document. The image forming apparatus 1 may also have a function for reading, when it is determined that a marking exists and contains predetermined information, the information.

The specific marking is attached to the original document 100, when the original document 100 is already digitized to generate an electronic document. The original document 100 to which the specific marking is attached indicates that the electronic document thereof already exists. Thus, the attachment of the specific marking makes it possible to determine whether or not an electronic document for the original document 100 exists.

Various types of marking are possible as the specific marking. For example, a stamp indicating information “electronic-document generated” may be applied to a portion of the original document 100 or such information may be provided in a barcode form. Alternatively, a small hole may be provided at one edge of the original document 100.

When the image forming apparatus 1 is set to the “special mode” and the marking detecting unit 3 detects the specific marking, the determining unit 4 prohibits the generation of an electronic document based on the read original image data. This arrangement prevents electronic documents for a special document, such as a tax/finance-related document, from redundantly generated.

The arrangement may also such that, when the specific marking has predetermined information as with a barcode, the information is identified and the generation of an electronic document is prohibited based on the information.

The determining unit 4 can also determine whether each read original document 100 is a document whose electronic document already exists (hereinafter referred to as a “read-completion document 110”) or a document whose electronic document is to be newly generated (hereinafter referred to as a “new read document 120”).

The marking attaching unit 6 attaches the specific marking to the new read document 120 of the read original documents 100. Since the read-completion document 110 has already the specific marking attached thereto, the marking attaching unit 6 does not attach any marking. The read-completion document(s) 110 and the new read document(s) 120 are distinguished from each other based on the determination result of the determining unit 4.

The form of the specific marking attached by the marking attaching unit 6 is similar to the form of the marking detected by the marking detecting unit 3.

The discharging unit 9 automatically discharges the read original document(s) 100 to a tray or the like. During the discharge, in accordance with the determination result of the determining unit 4, the discharging unit 9 sorts and discharges the read-completion document(s) 110 and the new read document(s) 120.

When the reading unit 2 reads the original documents 100, an ADF is typically used to read a large amount of documents. The original documents 100 input to the ADF may include both the read-completion documents 110 and the new read documents 120. In such a case, since the discharging unit 9 automatically sorts and discharges the read-completion documents 110 and the new read documents 120, convenience is improved.

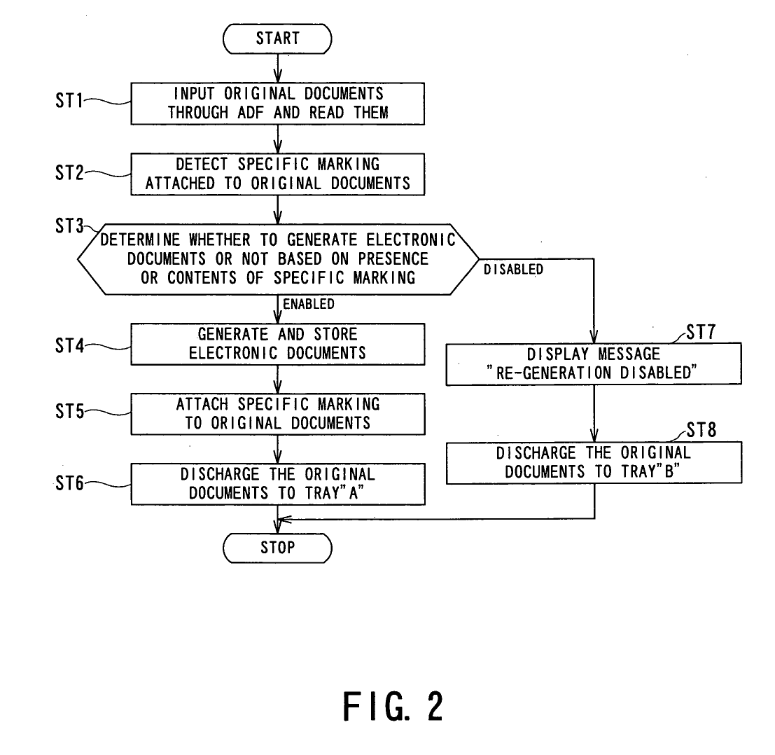

An example of the operation of the image forming apparatus 1 configured as described above will now be described with reference to a flow chart shown in FIG. 2. In the example of the operation shown in FIG. 2, it is assumed that the image forming apparatus 1 is preset to the “special mode”.

First, in step ST1, a user input multiple original documents 100 through the ADF and the reading unit 2 reads the original documents 100. These original documents 100 include both the read documents 110 and the new read documents 120.

Next, in step ST2, the marking detecting unit 3 determines whether or not the specific marking is attached to each original document 100. When the specific marking is a barcode or the like, the marking detecting unit 3 further reads the content of the marking.

Next, in step ST3, the determining unit 4 determines whether or not the generation of the electronic document is enabled in accordance with the presence/absence or the content of the specific marking.

When it is determined that the generation of the electronic document is “enabled”, the electronic-document generating unit 5 generates the electronic document in step ST4.

Subsequently, in step ST5, the specific marking is attached to the original document 100 (in this case, the original document 100 corresponds to the new read document 120).

In step ST6, the original document 100 to which the specific marking is attached, i.e., the new read document 120, is discharged from the discharging unit 9 to a tray “A”.

On the other hand, when it is determined in step ST3 that the generation of the electronic document is “disabled”, in step ST7, a message “re-generation disabled” or the like is displayed on the operation displaying unit 7 to inform the user of the information. Thereafter, in step ST8, the original document 100 is discharged to a tray “B” (in this case, the original document 100 corresponds to the read-completion document 110 and already has the specific marking attached thereto).

Since the image forming apparatus 1 of the present embodiment can detect the specific marking attached to the original document(s) 100, it is possible to prohibit the generation of an electronic document for a document whose electronic document has already been generated and it is therefore possible to automatically prevent duplicated electronic documents from being mistakenly generated.

After an electronic document is generated, it is also possible to prevent a malicious third party from tampering with the original document 100 and generating a new electronic document based on the tampering.

In addition, the image forming apparatus 1 of the present embodiment is configured to distinguish between the original document 100 (the read-completion document 110) whose electronic document has already been generated and the original document 100 (the new read document 120) whose electronic document is newly generated, and to automatically attach the specific marking to the new read document 120. This arrangement, therefore, can eliminate labor for manually attaching the marking to the document and can prevent human-induced error, thus ensuring high security.

In addition, since the image forming apparatus 1 of the present embodiment is configured so as to separately discharge the read-completion document(s) 110 and the new read document(s) 120, usability is improved.

The present invention is not only limited to the particular embodiment described above, and in practice, the elements described above can be modified and embodied without departing from the spirit and scope of the present invention. Some of the elements disclosed in the embodiment can be appropriately combined to achieve various modifications of the present invention. For example, some of the elements disclosed in the embodiment may be eliminated.

What is claimed is:

1. An image forming apparatus, comprising:
a reading unit that reads at least one original document and that generates original image data;
a marking detecting unit that detects a specific marking attached to the original document, the marking indicating that an electronic document of the original document has already been generated;
a determining unit that determines whether generation of the electronic document is enabled or disabled in accordance with the presence/absence or content of the detected marking; and
an electronic-document generating unit that does not generate the electronic document, when the determining unit determines that the generation of the electronic document is disabled, and that generates the electronic document in accordance with the original image data, when the determining unit determines that the generation of the electronic document is enabled.

2. The image forming apparatus according to claim 1, further comprising a marking attaching unit, wherein when the electronic document is generated, the marking attaching unit attaches a specific marking to the original document from which the electronic document is generated.

3. The image forming apparatus according to claim 1, further comprising a discharging unit that discharges the original documents after the original documents are read, wherein the discharging unit sorts and discharges an original document determined by the determining unit that the generation of the electronic document thereof is enabled and an original document determined by the determining unit that the generation of the electronic document thereof is disabled.

4. The image forming apparatus according to claim 1, further comprising a display unit that displays, when the determining unit determines that the generation of the electronic document is disabled, information indicating the disabling of the generation.

5. The image forming apparatus according to claim 1, wherein the specific marking attached to the original document comprises at least one of markings provided by a stamp, a barcode, and a hole indicating that the electronic document has already been generated.

6. An image forming method, comprising the steps of:
reading at least one original document and generating original image data;
detecting a specific marking attached to the original document;
determining whether generation of an electronic document of the original document is enabled or disabled in accordance with the presence/absence or content of the detected marking; and
not generating the electronic document, when it is determined in the determining step that the generation of the electronic document is disabled, and generating the electronic document in accordance with the original image data, when it is determined in the determining step that the generation of the electronic document is enabled.

7. The image forming method according to claim 6, further comprising a step of attaching, when the electronic document is generated, a specific marking to the original document from which the electronic document is generated.

8. The image forming method according to claim 6, further comprising a step of discharging the original documents after the original documents are read, wherein in the discharging step, an original document determined by the determining unit that the generation of the electronic document thereof is enabled and an original document determined by the determining unit that the generation of the electronic document thereof is disabled are sorted and discharged.

9. The image forming method according to claim 6, further comprising a step of displaying, when the generation of the electronic document is disabled in the determining step, information indicating the disabling of the generation.

10. The image forming method according to claim 6, wherein the specific marking attached to the original document comprises at least one of markings provided by a stamp, a barcode, and a hole indicating that the electronic document has already been generated.
